(19) United States
(12) Patent Application Publication
(10) Pub. No.: US 2011/0196594 A1
(43) Pub. Date: Aug. 11, 2011

(54) CONTROLLER FOR FUEL INJECTION SYSTEM

(75) Inventor: Jun HASEGAWA, Komaki-city (JP)

(73) Assignee: DENSO CORPORATION, Kariya-city (JP)

(21) Appl. No.: 13/023,697

(22) Filed: Feb. 9, 2011

(30) Foreign Application Priority Data
Feb. 10, 2010 (JP) 2010-27172

(51) Int. Cl. F02D 41/30

(52) U.S. Cl. 701/103

(57) ABSTRACT

A controller controls a control input of a fuel pump in such a manner that a fuel pressure in a delivery pipe agrees with a target fuel pressure. A correction input is computed for compensating a fuel pressure reduction except due to a fuel injection through the fuel injector. The control input of the fuel pump is controlled so that the fuel pump discharges the fuel according to the correction input.

### CROSS-REFERENCE TO RELATED APPLICATION

This application is based on Japanese Patent Application No. 2010-27172 filed on Feb. 10, 2010, the disclosure of which is incorporated herein by reference.

### FIELD OF THE INVENTION

The present invention relates to a controller for a fuel supply system of an internal combustion engine.

### BACKGROUND OF THE INVENTION

A direct fuel injection engine is well known, in which fuel is directly injected into a cylinder. In this fuel supply system, a high-pressure fuel supplied from a fuel pump is accumulated in a fuel-supply-passage portion. Then, the accumulated high-pressure fuel is supplied to the fuel injector of each cylinder through pipes (high-pressure fuel passage) provided for each cylinder.

In such a fuel supply system, as shown in JP-2001-336436A, an accumulated fuel pressure is detected by a fuel pressure sensor. A fuel injection quantity is computed based on the detected fuel pressure, whereby an air-fuel ratio is properly controlled.

Further, it is well known that the fuel pump is provided with a check valve for avoiding a reverse flow of the fuel. Also, the fuel pump is provided with a pressure reduction mechanism in order to intentionally reduce the fuel pressure after the engine is shut down. For example, JP-2009-79564A shows a fuel pump provided with a check valve which includes an orifice. After the engine is shut down, the fuel is returned to the fuel pump through the orifice so that the fuel pressure in the fuel-supply-passage portion is reduced.

In order to properly control fuel injection quantity, it is necessary to properly control the fuel pressure in the fuel-supply-passage portion. Meanwhile, even when no fuel is injected by an injector, the fuel pressure in the fuel-supply-passage portion may be reduced due to a fuel leak. Especially, in the fuel pump provided with the pressure reduction mechanism, a fuel pressure reduction quantity becomes large. In such a case, it is likely that a fuel injection can not be performed precisely due to the fuel pressure reduction.

### SUMMARY OF THE INVENTION

The present invention is made in view of the above matters, and it is an object of the present invention to provide a controller for a fuel supply system of an internal combustion engine, which is capable of performing a fuel injection control precisely even if the fuel pump is configured to have a fuel pressure reduction mechanism in which the fuel pressure in the fuel-supply-passage portion can be reduced under a condition that no fuel is injected.

A fuel supply system includes a fuel pump discharging a fuel and a fuel-supply-passage portion accumulating the fuel discharged from the fuel pump in order to supply the fuel to a fuel injector. The controller controls a control input of the fuel pump in such a manner that a fuel pressure in the fuel-supply-passage portion agrees with a target fuel pressure.

Further, the controller includes: a computing means for computing a correction input which compensates a fuel pressure reduction except due to a fuel injection through the fuel injector; and a pump control means for controlling the control input of the fuel pump so that the fuel pump discharges the fuel according to the correction input computed by the computing means.

According to the above configuration, the correction input which compensates a fuel pressure reduction is computed and the control input of the fuel pump is controlled according to the correction input. Thus, even if a fuel pressure reduction is generated except due to the fuel injection through the fuel injector, the fuel pressure in the fuel-supply-passage portion can be close to the target fuel pressure. Consequently, the fuel pressure in the fuel-supply-passage portion can be easily maintained at the target fuel pressure. Thus, the fuel injection control can be appropriately conducted.

According to a second aspect of the present invention, the computing means computes the correction input based on the fuel pressure in the fuel-supply-passage portion during a fuel-cut period in which no fuel is injected through the fuel injector while the engine is running. Thereby, even if the fuel-supply-passage portion has an individual difference and an error due to its aging, the correction input can be properly obtained, which corresponds to the pressure reduction. Especially, since the correction input is computed during the fuel-cut period, it is unnecessary to consider fuel injection quantity through the fuel injector. Thus, the appropriate correction input can be obtained without complicate computation.

According to a third aspect of the present invention, the controller further includes an obtaining means for obtaining an actual fuel pressure in the fuel-supply-passage portion from a fuel pressure sensor; and a feedback control means for computing a feedback control input based on a deviation between the actual fuel pressure and the target fuel pressure.

The pump control means controls the control input of the fuel pump in such a manner that the fuel pump discharges the fuel in accordance with the correction input and the feedback control input.

Further, the computing means computes the correction input by utilizing the feedback control input computed by the feedback control means during the fuel-cut period. Thereby, the correction input can be computed by executing the feedback control during the fuel-cut period. A configuration for computing the correction input can be simplified.

According to a fourth aspect of the invention, the feedback control means computes an integral term of the deviation as a part of the feedback control input, and the computing means computes the correction input by utilizing the integral term. Thus, a variation in the correction input can be restricted.

According to a fifth aspect of the invention, the controller further includes a clear executing means for clearing the integral term after the fuel-cut period is started. The computing means computes the correction input by utilizing another integral term after the integral term is cleared by the clear executing means. Thereby, an effect due to a variation in the actual fuel pressure immediately before the fuel-cut period can be cancelled. The correction input can be promptly computed by using the integral term.

According to a sixth aspect of the invention, the fuel supply system is provided with a pressure reduction means for reducing the fuel pressure in the fuel-supply-passage portion by discharging the fuel therefrom in a direction away from the fuel injector by means of the fuel pressure in the fuel-supply-passage portion. The computing means computes the correction input for compensating a fuel quantity which the fuel pressure reduction means discharges from the fuel-supply-passage portion.

In a fuel supply system provided with a pressure reduction means, even during the fuel-cut period, the fuel pressure in the fuel-supply-passage portion can be reduced. Thus, when the fuel-cut period is terminated, the fuel injection control can be properly conducted.

Further, since the pressure reduction means reduces the fuel pressure by means of the fuel pressure in the fuel-supply-passage portion, its structure can be made simple.

Furthermore, it can be avoided that the fuel reduction occurs during the fuel-supply period and the actual fuel pressure easily deviates from the target fuel pressure.

According to a seventh aspect of the present invention, the fuel supply system is provided with a pressure reduction means for reducing the fuel pressure in the fuel-supply-passage portion by discharging the fuel therefrom in a direction away from the fuel injector. Further, the pressure reduction means reduces the fuel pressure in the fuel-supply-passage portion to a specified target fuel pressure in a fuel-cut period.

The controller further includes an obtaining means for obtaining an actual fuel pressure in the fuel-supply-passage portion from a fuel pressure sensor; and a feedback control means for computing a feedback control input based on a deviation between the actual fuel pressure and the target fuel pressure.

The pump control means controls the control input of the fuel pump in such a manner that the fuel pump discharges the fuel in accordance with the correction input and the feedback control input. The computing means computes the correction input for compensating a fuel quantity which the fuel pressure reduction means discharges from the fuel-supply-passage portion. Further, the computing means computes the correction input by utilizing the feedback control input in a case that the deviation becomes within a specified range after the fuel-cut period is started.

According to this configuration, even if the fuel-cut period is terminated earlier than expected, the fuel injection control can be properly conducted. Thus, a variation in the correction input can be restricted.

According to an eighth aspect of the invention, the control input defines a start timing of a fuel discharge from the fuel pump, the pressure reduction means discharges the fuel from the fuel-supply-passage portion when the fuel pump pressurizes no fuel, and prevents the fuel from flowing out from the fuel-supply-passage portion when the fuel pump pressurizes the fuel in order to discharge the fuel.

The computing means computes the correction input which advances the start timing of the fuel discharge as the start timing of the fuel discharge corresponding to the control input except the correction input is retarded. If the pressure reduction period is prolonged, the pressure reduction function is enhanced during the fuel-cut period. However, not during the fuel-cut period, the pressure reduction varies depending on the start timing. According to the eighth aspect, since the correction input is computed according to the start timing, a compensation for the pressure reduction can be properly conducted.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1 is a schematic block diagram showing an engine control system;

FIG. 2 is a schematic chart showing the high-pressure pump;

FIG. 3 is a cross-sectional view illustrating a part of the pressure reduction mechanism;

FIG. 4 is a time chart for explaining an operation of the high-pressure pump;

FIG. 5 is a time chart for explaining an advantage of the constant residual pressure valve;

FIG. 6A is a time chart for explaining an energization start timing which is determined during a fuel-supply period;

FIG. 6B is a time chart for explaining an energization start timing which is determined in order to maintain the fuel pressure in the delivery pipe during a fuel-cut period;

FIG. 7 is a functional block diagram for computing energization start timing;

FIG. 8 is a flowchart showing a control input computing processing;

FIG. 9 is a time chart showing a case in which learning is executed;

FIG. 10 is a flowchart showing a second control input computing processing; and

FIG. 11 is a time chart showing a case in which learning is executed.

### DETAILED DESCRIPTION OF EMBODIMENTS

### First Embodiment

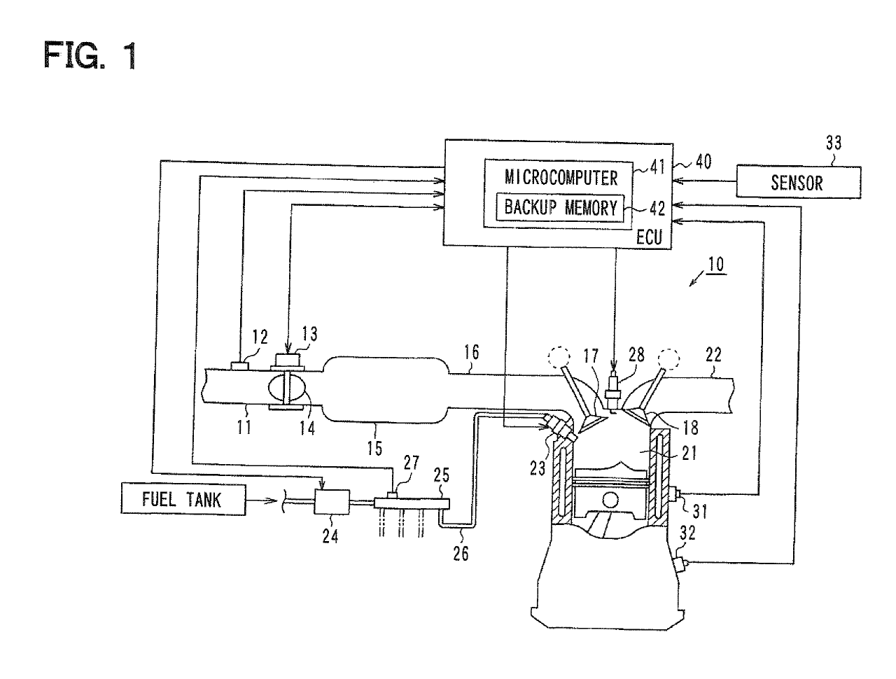

Hereinafter, a first embodiment that embodies the present invention will be described with reference to the drawings. In the present embodiment, the internal combustion engine is a multi-cylinder four-cycle direct injection gasoline engine. An engine control system includes an electronic control unit (ECU) which executes a fuel injection control, an ignition timing control and the like. FIG. 1 shows an entire engine control system.

An airflow meter 12 is disposed at upstream portion of an intake pipe 11. The airflow meter 12 detects an intake air flow rate flowing through the intake pipe 11. A throttle valve 14 is provided downstream of the air flow meter 12. The throttle valve 16 is electrically driven by a throttle actuator 13 such as a DC motor. A position of the throttle valve 14 is detected by a throttle position sensor (not shown) provided in the throttle actuator 13. A surge tank 15 including an intake air pressure sensor (not shown) is arranged downstream of the throttle valve 14. The intake air pressure sensor detects intake air pressure. An intake manifold 16 which introduces air into each cylinder of the engine 10 is arranged downstream of the surge tank 15. The intake manifold 16 is connected to an intake port of each cylinder.

An intake valve 17 and an exhaust valve 18 are respectively provided to an intake port and an exhaust port of the engine 10. When the intake valve 17 is opened, the air in the surge tank 15 is introduced into the combustion chamber 21. When the exhaust valve 18 is opened, exhaust gas is discharged into the exhaust pipe 24.

A fuel injector 23 is provided on an upper portion of each cylinder of the engine 11 to inject fuel directly into the cylinder. The fuel in a fuel tank (not shown) is supplied to the fuel injector 23. Specifically, the fuel in the fuel tank is pumped up by a low-pressure pump and then pressurized by a mechanical high-pressure pump 24. This high-pressure fuel is supplied to the delivery pipe 25 from the high-pressure pump 24. The delivery pipe 25, which functions as a fuel-supply-passage portion, accumulates the high-pressure fuel therein. Its resisting pressure is 30 MPa, for example. Then, the high-pressure fuel is introduced into each fuel injector 23 through a fuel supply pipe 26, and then injected into the combustion chamber 21. A fuel pressure sensor 27 which detects pressure of the fuel (fuel pressure) in the delivery pipe 25 is provided to the delivery pipe 25.

A spark plug 28 is provided for each cylinder on a cylinder head of the engine 10. The spark plug 28 receives high voltage from an ignition apparatus (not shown) at specified ignition timing. The spark plug 28 generates spark to ignite the air-fuel mixture in the combustion chamber 21.

Further, the engine 10 is provided with a coolant temperature sensor 31 detecting an engine coolant temperature, a crank angle sensor 32 outputting a crank angle signal at a predetermined crank angle (for example, 10° CA) and the like. An accelerator position sensor 33 detecting an accelerator position is also provided to the vehicle.

The ECU 40 is mainly constructed of a microcomputer 41 having a CPU, a ROM, a RAM and a backup memory 42. The ECU 40 receives various detection signals from the fuel pressure sensor 27, the coolant temperature sensor 31, the crank angle sensor 32, the accelerator position sensor 33 and the like. The ECU 40 executes a fuel injection quantity control, an ignition timing control and a high-pressure pump discharge quantity control based on the above detection signals. The fuel pressure in the delivery pipe 25 may be estimated instead of actually detecting.

The microcomputer 41 computes a basic fuel injection quantity based on an engine driving condition and corrects the fuel pressure (injection pressure) in the delivery pipe 25 according to the basic fuel injection quantity.

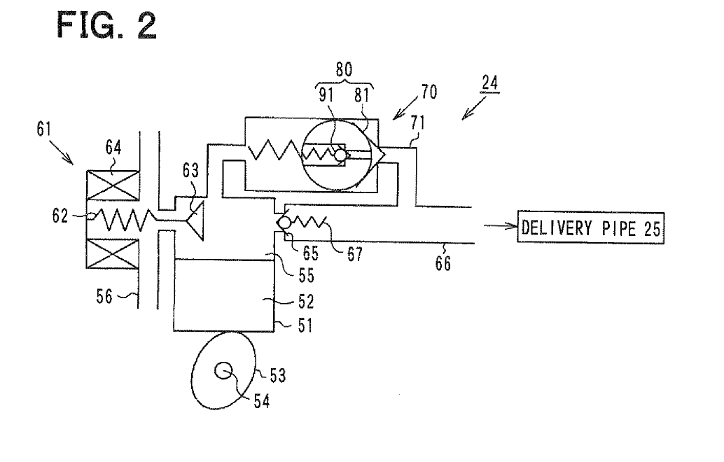

The high-pressure pump 24 will be described in detail hereinafter. FIG. 2 is a schematic chart showing the high-pressure pump 24.

The high-pressure pump 24 is mechanically connected to a crankshaft of the engine 10. In the present embodiment, a fuel discharge cycle of the high-pressure pump 24 is identical to a fuel injection cycle of the fuel injector 23.

The high-pressure pump 24 has a cylinder 51 in which a plunger 52 is slidablly provided. One end of the plunger 52 is in contact with a cam 53 which is fixed to a camshaft 54. The plunger 52 reciprocates in the cylinder 51 along with a rotation of the cam 53.

A pressurization chamber 55 is defined in the cylinder 51. The pressurization chamber 55 fluidly communicates with a low-pressure passage 56. When the plunger 52 slides down to increase a volume of the pressurization chamber 55, the fuel in the low-pressure passage 56 is suctioned into the pressurization chamber 55.

An electromagnetic valve 61 is disposed between the pressurization chamber 55 and the low-pressure passage 56. The electromagnetic valve 61 is comprised of a suction valve 63 and a coil 64. The suction valve 63 is normally opened by a spring 62, so that the pressurization chamber 55 communicates with the low-pressure passage 56. When the coil 64 is energized, the suction valve 63 is closed.

When the suction valve 63 is opened and the plunger 52 slides down, the fuel is suctioned into the pressurization chamber 55. Even when the suction valve 63 is opened and the plunger 52 slides up, the fuel in the pressurization chamber is returned to the low-pressure passage 56.

When the suction valve 63 is closed and the plunger 52 slides up, the fuel in the pressurization chamber 55 is pressurized. This pressurized fuel is discharged into a high-pressure passage 66 communicating with the delivery pipe 25 when a check valve (discharge valve) 65 is opened. The check valve 65 is biased by a spring 67. When the fuel pressure in the pressurization chamber 55 exceeds a predetermined value, the check valve 65 is opened so that the pressurization chamber 55 communicates with the high-pressure passage 66.

The fuel pressure in the high-pressure passage 66 and the delivery pipe 25 is increased by receiving the pressurized fuel from the pressurization chamber 55. Meanwhile, when the fuel injector 23 injects the fuel, the fuel pressure in the high-pressure passage 66 and the delivery pipe 25 is decreased. Further, the high-pressure pump 70 is provided with a pressure reduction mechanism 70 which can reduce the fuel pressure in the high-pressure passage 66 and the delivery pipe 25 even when the fuel injector 23 injects no fuel.

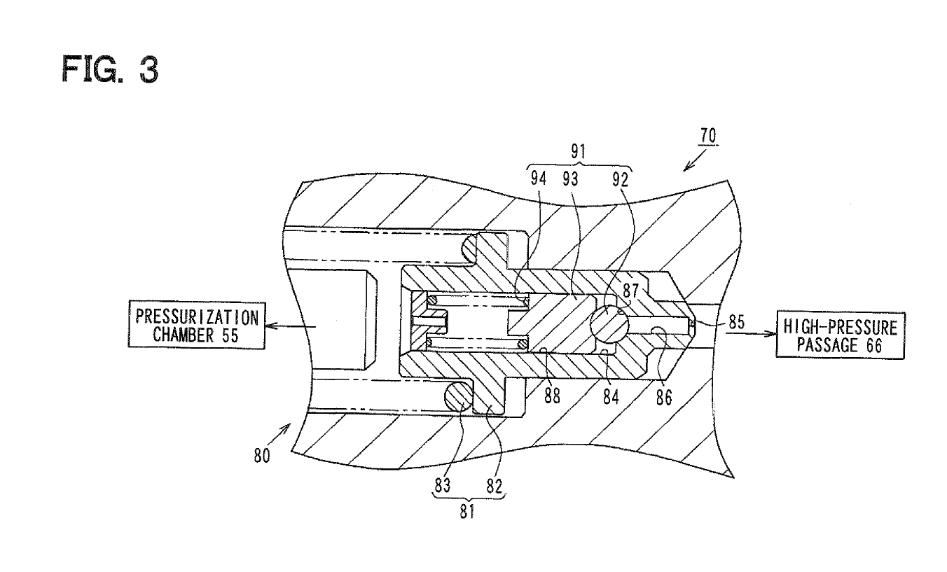

Referring to FIGS. 2 and 3, the pressure reduction mechanism 70 will be described in detail. FIG. 3 is a cross-sectional view illustrating a part of the pressure reduction mechanism 70.

As shown in FIG. 2, the pressure reduction mechanism 70 has a return passage 71 through which the fuel in the high-pressure passage 66 returns to the pressurization chamber 55. Further, the pressure reduction mechanism 70 has a pressure adjusting portion 80 which allows or prevents the fuel-return through the return passage 71.

The pressure regulation portion 80 includes a mechanical relief valve 81 and a mechanical constant residual pressure valve 91. As shown in FIG. 3, the relief valve 81 is disposed in a region of the return passage 71 of which inner diameter is stepwise reduced in a direction from the pressurization chamber 55 to the high-pressure passage 66. The relief valve 81 has a relief valve body 82 and a spring 83 biasing the relief valve body 82 toward the high-pressure passage 66. Receiving a biasing force of the spring 83, a top end surface of the relief valve body 82 is brought into contact with a small-diameter step surface (valve seat) of the return passage 71, whereby a fuel-return through a clearance between the relief valve body 82 and the return passage 71 is prevented.

Meanwhile, when the fuel pressure in the high-pressure passage 66 exceeds a specified value, the relief valve 81 is opened against a biasing force of the spring 83, so that the fuel is returned through the clearance between the relief valve body 82 and the return passage 71. The relief valve 81 is for avoiding an excessive increase in fuel pressure in the high-pressure passage 66. For example, when the fuel pressure in the high-pressure passage 66 is larger than that in the pressurization chamber 55 by 25 MPa to 30 MPa, the relief valve 81 is opened.

The relief valve body 82 is cylindrically shaped and has a fuel passage 84 which connects the high-pressure passage 66 and the pressurization chamber 84. A flow passage area of the fuel passage 84 is stepwise increased in a direction from the high-pressure passage 66 to the pressurization chamber 55. Specifically, the fuel passage 84 is comprised of an orifice portion 85, a middle inner diameter portion 86, and a large inner diameter portion 88. A step portion 87 is formed between the middle inner diameter portion 86 and the large inner diameter portion 88. The constant residual pressure valve 91 is arranged in the large inner diameter portion 88.

The constant residual pressure valve 91 is comprised of a spherical valve body 92, a column body 93, and a spring 94. The spring 94 biases the spherical valve body 92 toward the step portion 87 through the column body 93. When the spherical valve body 92 is brought into contact with the step portion 87, the constant residual pressure valve 91 is closed, so that a fuel-return through a clearance between the column body 93 and the relief valve body 82 is prevented. Meanwhile, when the fuel pressure in the high-pressure passage 66 exceeds a specified value, the constant residual pressure valve 92 is opened against a biasing force of the spring 93, so that the fuel can be returned through the clearance between the column body 93 and the relief valve body 82.

The constant residual pressure valve 91 is for returning the fuel in the high-pressure passage 66 to the pressurization chamber 66 so that the fuel pressure in the high-pressure passage 66 is reduced. Further, the constant residual pressure valve 91 is for avoiding that the fuel pressure (residual fuel pressure) in the high-pressure passage 66 becomes lower than a lower limit pressure. For example, when the fuel pressure in the high-pressure passage 66 exceeds the fuel pressure in the pressurization chamber 55 by 3 MPa, the constant residual pressure valve 91 is opened.

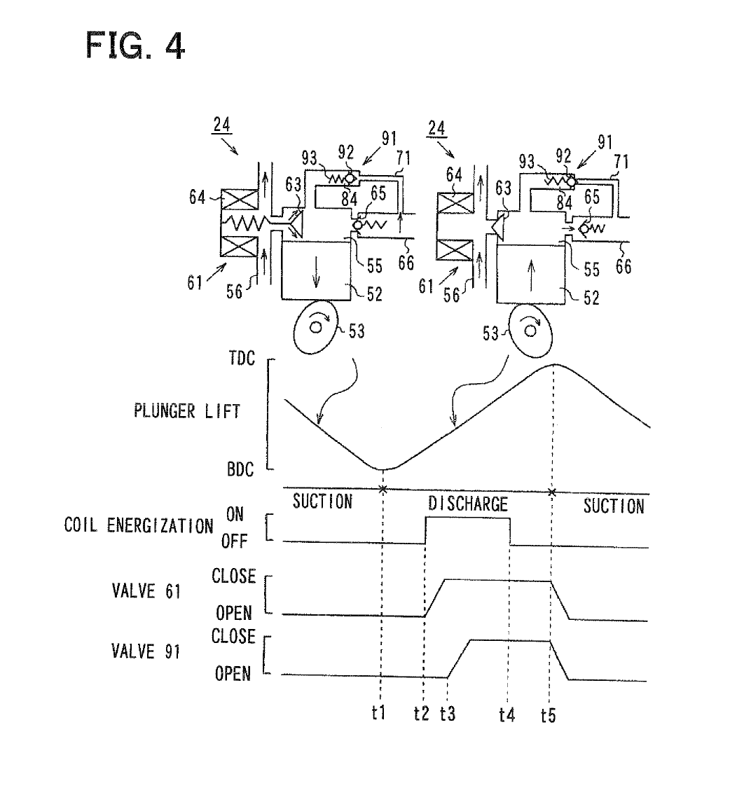

Referring to FIG. 4, an operation of the high-pressure pump 24 will be described hereinafter. FIG. 4 is a time chart for explaining an operation of the high-pressure pump 24. In FIG. 4, the relief valve 81 is not illustrated for easy understanding. In the following description, it is assumed that the relief valve 81 is closed.

When the plunger 52 slides down to increase the volume of the pressurization chamber 52, the coil 64 is deenergized to open the suction valve 63. The pressurization chamber 55 communicates with the low-pressure passage 56 and low-pressure fuel is suctioned into the pressurization chamber 55 (suction stroke).

If the fuel pressure in the high-pressure passage 66 is significantly larger than that in the pressurization chamber 55 during the suction stroke, the constant residual pressure valve 91 is opened. Thus, the fuel in the high-pressure passage 66 returns to the pressurization chamber 55 through the return passage 71 and the fuel passage 84, so that the fuel pressure in the high-pressure passage 66 and the delivery pipe 25 is reduced. Since the fuel passage 84 has the orifice portion 85 as described above, the fuel returns little by little.

At a time t1, the plunger 52 is at a bottom dead center and the coil 64 is not energized. The suction valve 63 is opened, so that the fuel in the pressurization chamber 55 is returned to the low-pressure passage 56. Further, the constant residual pressure valve 91 is maintained to be opened, so that the fuel in the high-pressure passage 66 is still returned to the pressurization chamber 55.

When the coil 64 is energized at a timing t2, the suction valve 63 is closed slightly later. The fuel pressure in he pressurization chamber 55 is increased and the high-pressure fuel is discharged to the delivery pipe 25 through the high-pressure passage 66 (discharge stroke). That is, if the coil energization timing t2 is advanced, the discharge quantity of the high-pressure pump 24 is increased. If the coil energization timing t2 is retarded, the discharge quantity of the high-pressure pump 24 is decreased.

At a timing t3 before the high-pressure fuel is discharged to the high-pressure passage 66, a differential pressure between the pressurization chamber 55 and the high-pressure passage 66 becomes less than the biasing force of the spring 93. The spherical valve body 92 starts to move to the close position. Finally, the constant residual pressure valve 91 is fully closed. Thereby, the fuel-return from the high-pressure passage 66 to the pressurization chamber 55 is terminated. At timing when the high-pressure fuel is discharged to the high-pressure passage 66, the constant residual pressure valve 92 is closed. Thus, it is unnecessary to pay attention to the fuel-return when pressurizing the fuel.

In FIG. 4, the coil 64 is deenergized at a timing t4. After the timing t4, the electromagnetic valve 61 is closed by the fuel pressure in the pressurization chamber 55.

At a time t51, the plunger 52 is at a top dead center. Then, the plunger 52 slides down, the pressure in the pressurization chamber 55 is decreased. The fuel pressure in the pressurization chamber 55 becomes lower than that in the high-pressure passage 66. The constant residual pressure valve 91 opened by the differential pressure and a biasing force of the spring 93 during the suction stroke. The suction valve 63 is also opened. It should be noted that the both valves may be opened at the same time. Alternatively, both valves may be opened at slightly different timings.

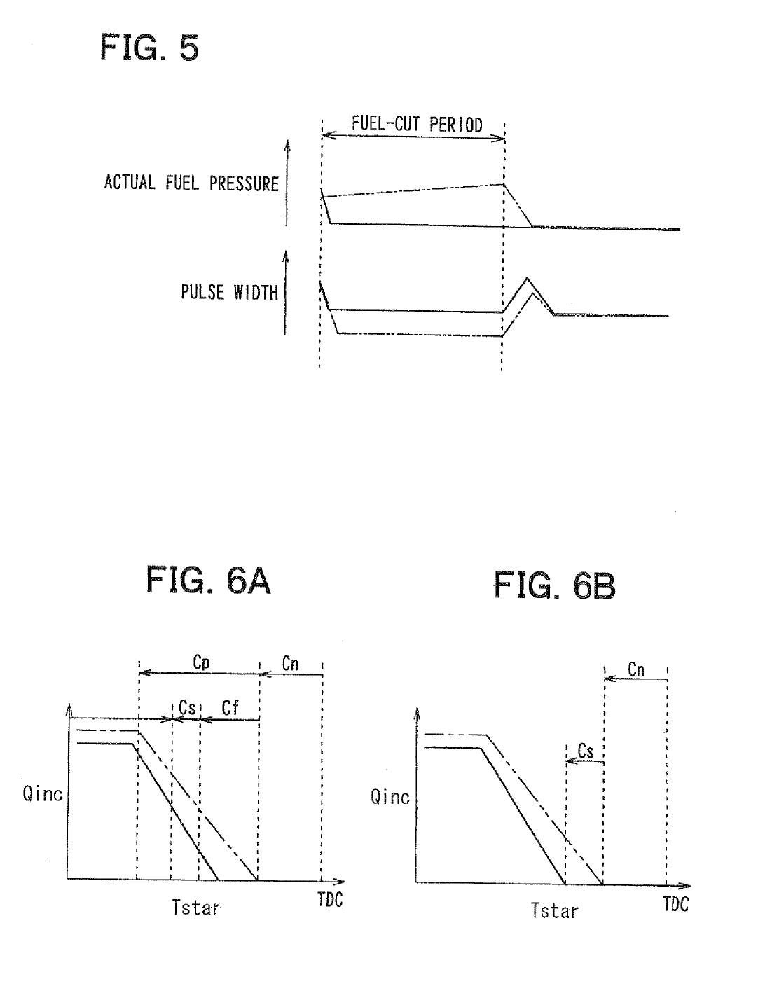

FIG. 5 is a time chart for explaining an advantage of the constant residual pressure valve 91. Specifically, FIG. 5 shows an actual fuel pressure in the delivery pipe 25 and a pulse width which can be applied to the fuel injector 23. In

FIG. 5, solid lines represent the present embodiment having the constant residual pressure valve 91 and two-dot chain lines represent a conventional high-pressure pump having no pressure reduction mechanism such as the constant residual pressure valve.

Further, in FIG. 5, a fuel-cut period represents a period in which an accelerator pedal is not stepped and the fuel injection is stopped while the engine speed is greater than a specified value. During the fuel-cut period, no torque is generated on the crankshaft.

In the conventional high-pressure pump represented by two-dot chain lines, during the fuel-cut period, the fuel pressure in the delivery pipe 25 is substantially maintained at the pressure of before the fuel-cut period. Further, depending on an engine temperature, it is likely that the fuel pressure is increased more than the engine temperature of before the fuel-cut period. In such a conventional high-pressure pump, if it becomes necessary to generate the torque on the crankshaft during the fuel-cut period, the fuel injection should be performed by a minimum quantity. However, the fuel pressure in the delivery pipe 25 is excessively high and the pulse width which can be applied to the fuel injector 23 becomes narrow as shown by two-dot chain line. Thus, the fuel can not be injected sufficiently based on such a narrow pulse width.

On the other hand, according to the present embodiment represented by solid lines in FIG. 5, since the constant residual pressure valve 91 can reduce the fuel pressure even during the fuel-cut period, the fuel pressure in the delivery pipe 25 can be set to desired value. Thereby, a sufficient pulse width can be ensured even if it becomes necessary to generate the torque on the crankshaft during the fuel-cut period.

In a configuration where the constant residual pressure valve 91 is maintained to be opened by itself when the electromagnetic valve 61 is opened, the fuel is returned to the pressurization chamber 55 to reduce the fuel pressure in the delivery pipe 25 irrespective of whether the fuel-cut is conducted. When it is assumed that the energization start timing of the electromagnetic valve 61 is identical, the increased fuel quantity in the delivery pipe 25 by one discharge of the high-pressure pump 24 is smaller than that of the conventional high-pressure pump having no pressure reduction mechanism. Therefore, in the present embodiment, the energization start timing of the electromagnetic valve 61 is established in view of the returned fuel quantity. Further, even in a case that the fuel pressure in the delivery pipe 25 is kept at a target fuel pressure during the fuel-cut period, the fuel discharge quantity of the fuel pump is necessary to be determined in view of the returned fuel quantity.

A fuel discharge quantity control by the ECU 40 will be described hereinafter. FIG. 6A is a time chart for explaining an energization start timing (° CA) which is determined during a fuel-supply period. FIG. 6B is a time chart for explaining an energization start timing (° CA) which is determined in order to maintain the fuel pressure in the delivery pipe during the fuel-cut period. In each of FIGS. 6A and 6B, a vertical axis represents an increased fuel quantity “Qinc” in the delivery pipe 25 during one stroke of the plunger 52 between the top dead center and the bottom dead center. A horizontal axis represents an energization start timing “Tstar” (° CA) of the electromagnetic valve 61.

The ECU 40 determines the energization start timing of the electromagnetic valve 61 by using of an uncontrollable control input “Cn”, an effective control input “Cp”, a feed control input “Cf” and a correction control input “Cs”.

The uncontrollable control input “Cn” is a control input corresponding to a period from a top dead center, in which the fuel can not be discharged even if the electromagnetic valve 61 is energized. The effective control input “Cp” is a control input corresponding to a period in which the discharge quantity of the fuel pump can be controlled according to the energization start timing of the electromagnetic valve 61. The feed control input “Cf” is a control input corresponding to a discharge quantity of the fuel pump which is necessary to increase the fuel pressure in the delivery pipe 25 to the target fuel pressure. The correction control input “Cs” is a control input for compensating the fuel quantity which is returned to the pressurization chamber 55 through the constant residual pressure valve 91. Based on the above feed control input “Cf” and the correction control input “Cs”, the actual fuel pressure in the delivery pipe 25 comes close to the target fuel pressure.

During the fuel-supply period, as shown in FIG. 6A, the energization start timing is determined as an advance quantity of the “Cn”, “Cf” and “Cs” relative to the top dead center of the plunger 52. Meanwhile, in a case that the fuel pressure in the delivery pipe 25 is maintained at the target fuel pressure during the fuel-cut period, the energization start timing is determined as an advance quantity of the “Cn” and the “Cs” relative to the top dead center of the plunger 52, as shown in FIG. 6B. In the fuel-cut period, if the value of “Cs” is improper value during the fuel-cut period or if a deviation exists between the target fuel pressure and the actual fuel pressure, the energization start timing is determined in view of the “Cf” partially.

As described later, during the fuel-supply period and the fuel-cut period, the effective control input “Cp” is utilized when the correction control input “Cs” is used for determining the energization start timing.

All of the correction control input “Cs” can be previously determined in a design stage. However, the returned fuel quantity depends on an individual difference of the constant residual pressure valve 91 and an error due to aging thereof. Thus, in order to obtain an appropriate correction control input “Cs”, the correction control input “Cs” is comprised of a base correction control input “Csb” and a learning value “Csp” for correcting a deviation of the “Csb” relative to the actual returned fuel quantity. This learning value “Csb” is obtained during the fuel-cut period.

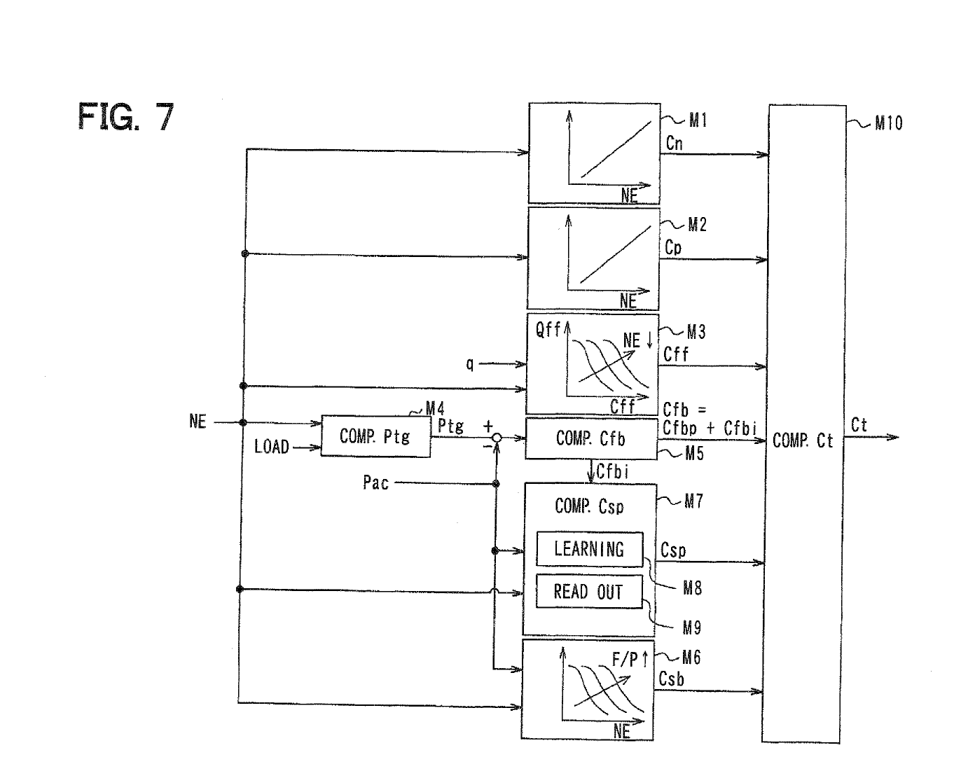

Referring to a block diagram shown in FIG. 7, a control function for determining the energization start timing (the discharge quantity of the pump) and a control function for utilizing the learning value “Csp” will be described.

In an uncontrollable control input computing unit M1, the “Cn” is computed based on an uncontrollable period computing table. This table defines a relationship between the “Cn” and an engine speed “NE”.

In an effective control input computing unit M2, the “Cp” is computed based on an effective period computing table. This table defines a relationship between the “Cp” and the engine speed “NE”.

In an FF control input computing unit M3, a feedforward control input “Cff” is computed. This feedforward control input “Cff” is included in the feed control input “Cf”. Specifically, the feedforward control (FF control) input “Cff” is computed based on a FF control input computing map which defines a relationship between a pump discharge quantity “Qff”, the engine speed “NE” and the feedforward control input “Cff”. The pump discharge quantity “Qff” corresponds to a pump discharge quantity which can compensate a fuel pressure reduction due to a fuel injection. That is, the quantity “Qff” corresponds to a fuel injection quantity “q” at timing immediately before the pump discharges the fuel. The FF control input “Cff” is represented as an advance quantity of the energization start timing (° CA) which is defined based on the “Cn”.

In a target fuel pressure computing unit M4, a target fuel pressure “Ptg” in the delivery pipe 25 is computed based on the engine speed “NE” and the engine load (for example, intake air flow rate detected by the air flow meter 12).

In an FB control input computing unit M5, a feedback control input “Cfb” is computed. This feedback control input “Cfb” is included in the feed control input “Cf”. Specifically in the FB control input computing unit M5, based on the target fuel pressure “Ptg” and the actual fuel pressure “Pac” detected by the fuel pressure sensor 27, the feedback control input “Cfb” is computed, which corresponds to a pump discharge quantity necessary for the actual fuel pressure “Pac” to agree with the target fuel pressure “Ptg”. In the present embodiment, a proportional term (P-term) “Cfbp” and an integral term (I-term) “Cfbi” are computed. These “Cfbp” and “Cfbi” are added together to obtain the FB control input “Cfb”.

The proportional term “Cfbp” is a value proportional to a deviation between the target fuel pressure “Ptg” and the actual fuel pressure “Pac”. The proportional term “Cfbp” is obtained by multiplying the deviation by a proportional gain. In this case, when the “Ptg” is greater than the “Pac”, the “Cfbp” is a positive value. When the “Pac” is greater than the “Ptg”, the “Cfbp” is a negative value.

The integral term “Cfbi” is a value corresponding to a summation of the deviation. The integral term “Cfbi” is obtained by multiplying the integral value of the deviation by an inverse of the integral gain. When summating the deviation, the deviation is a positive value or a negative value, not an absolute value.

These terms “Cfbp” and “Cfbi” are represented as an advance quantity of the energization start timing of the electromagnetic valve 61, which corresponds to the deviation. Specifically, during the fuel-supply period, these terms “Cfbp” and “Cfbi” are represented as an advance quantity of the energization start timing (° CA) which is defined based on the FF control input “Cff”. Meanwhile, during the fuel-cut period, these terms “Cfbp” and “Cfbi” are represented as an advance quantity or a retard quantity of the energization start timing (° CA) in a case that excess or deficiency of the fuel quantity in the delivery pipe 25 occurs.

It should be noted that the function for obtaining the actual fuel pressure “Pac” in the computing unit M5 corresponds to an obtaining means. Further, the function for obtaining the “Cfbp” and “Cfbi” corresponds to a feedback control means.

In a base pressure reduction computing unit M6, a base correction input

“Csb” of the correction control input “Cs” is computed based on a base correction computing map. This base correction computing map defines a relationship between the engine speed “NE”, the base correction input “Csb” and the actual fuel pressure “Pac”. The base correction input “Csb” is an advance quantity of the energization start timing, which corresponds to a fuel-return quantity. The base correction input “Csb” is the advance quantity corresponding to a case where an increase and decrease in fuel quantity in the delivery pipe 25 is zero while the plunger 52 reciprocates once between the top dead center and the bottom dead center.

In a learning value computing unit M7, a deviation of the base correction input “Csb” relative to an actual fuel-return quantity through the constant residual pressure valve 91 is learned, and this learning value input “Csp” is read out according to the current engine speed “NE” and the actual fuel pressure “Pac”.

Specifically, in a learning execution unit M8, the learning value input “Csp” is computed based on the integral term “Cfbi” which is computed in the computing unit M5 during the fuel-cut period. This learning value input “Csp” is stored in the backup memory 42 in relationship to the engine speed “NE” and the actual fuel pressure “Pac”. At the same time, the learning value input “Csp” is stored in the backup memory 41 in relationship to a specified range of the engine speed “NE” and a specified range of the actual fuel pressure “Pac”. Even if the learning value input “Csp” has been already stored in the corresponding specified range, the newly computed learning value input “Csp” is overwritten. The learning value input “Csp” is represented as an advance quantity of the energization start timing of the electromagnetic valve 61, which corresponds to the deviation in the base correction input “Csb”. Further, the learning value input “Csp” is the advance quantity corresponding to a case where an increase and decrease in fuel quantity in the delivery pipe 25 is zero while the plunger 52 reciprocates once between the top dead center and the bottom dead center.

In a learning value read unit M9, the learning value input “Csp”, which corresponds to current engine speed “NE” and the actual fuel pressure “Pac” is read out from the backup memory 42. In a case that the current engine speed “NE” and the actual fuel pressure “Pac” exist in a specified range for learning, the learning value input “Csp” is read out from this range. Since the learning is executed during the fuel-cut period, it is likely that the “NE” and “Pac” may not exist in the specified range for learning. If the “NE” and “Pac” do not exist in the specified range for learning, the learning value input “Csp” is read out from another range which is closest to the specified range. Further, a correction coefficient is computed according to the engine speed “NE” and the actual fuel pressure “Pac”, and this correction coefficient is multiplied by the learning value to obtain the present learning value input “Csp”.

It should be noted that the unit M6 and the unit M7 correspond to a computing means of the present invention.

In a final control input computing unit M10, a final control input “Ct” is computed based on the uncontrollable control input “Cn” computed in the unit M1, the effective control input “Cp” computed in the unit M2 the FF control input “Cff” computed in the unit M3, the FB control input “Cfb” computed in the unit M5, the base correction input “Csb” computed in the unit M6 and the learning value input “Csp” computed in the unit M7. This final control input “Cf” is represented as the energization start timing (° CA) of the electromagnetic valve 61.

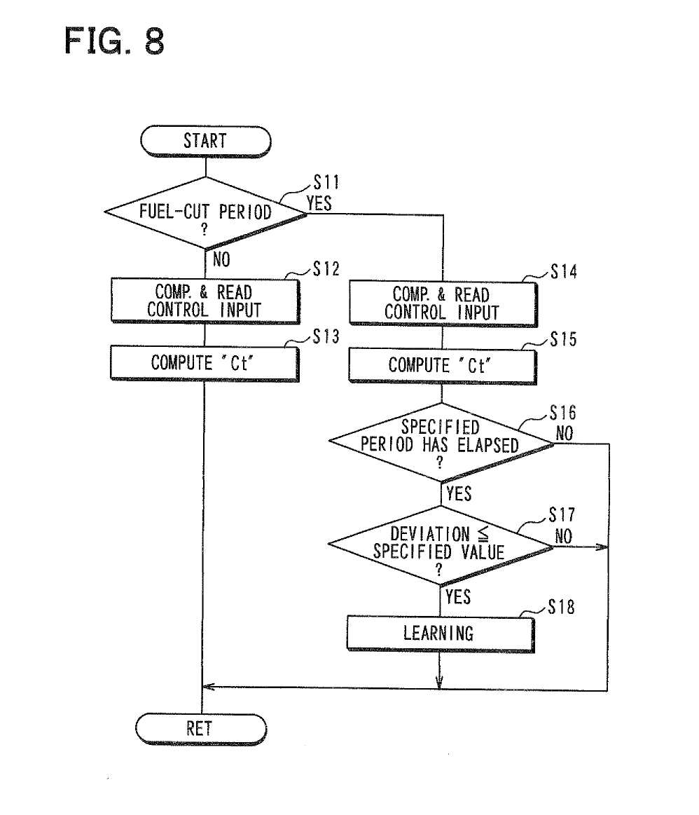

Referring to a flowchart shown in FIG. 8, a control input computing processing will be described hereinafter. This control input computing processing is executed when the plunger 52 is at the bottom dead center in the present embodiment.

In step S11, the computer determines whether it is in the fuel-cut period. When the answer is NO, the procedure proceeds to step S12 in which various control inputs are computed and read out. Specifically, the “Cn”, the “Cp”, the “Cff”, the “Cfb” and the “Csb” are computed. Further, the “Csp” is read out from the backup memory 42. If necessary, the “Csp” is multiplied by a correction coefficient. In a case that the corresponding learning value input “Csp” has not been learned yet, the learning value input “Csp” is zero in step S12 and step S14 which will be described later.

In step S13, the final control input “Ct” for the fuel-supply period is computed. Specifically, the “Ct” is computed according to the following formula (1).

Ct=180−(Cn+(Cff+Cfb)+K1(Csp+Csb)) (1)

wherein “K1” is a correction coefficient which is determined based on the actual fuel pressure “Pac” and a ratio between “180−(Cn+(Cff+Cfb))” and the “CP”.

Since the fuel-return is continued from a start of suction stroke until a start of pressurization stroke, the fuel-return quantity depends on the energization start timing of the electromagnetic valve 61. Specifically, as the energization start timing is retarded, the fuel-return quantity is increased. The advance quantity of the energization start timing, which is necessary to compensate the fuel-return quantity, depends on the computed final control input “Ct”. The base correction input “Csb” and the learning value input “Csp” are the advance quantity corresponding to a case where an increase and decrease in fuel quantity in the delivery pipe 25 is zero while the plunger 52 reciprocates once between the top dead center and the bottom dead center. Furthermore, the fuel-return quantity depends on the engine speed “NE” and the actual fuel pressure “Pac” even if the energization start timing is constant. The correction coefficient “K1” is for compensating a fuel pressure reduction speed relative to the discharge timing of the fuel.

It should be noted that a specific way for determining the correction coefficient “K1” is arbitrarily employed.

The electromagnetic valve 61 is energized at an energization start timing corresponding to the final control input “Ct” which is computed in step S13.

When the answer is NO in step S11, the procedure proceeds to step S14 in which various control inputs are computed and read out. Specifically, the “Cn”, the “Cp”, the “Cfb” and the “Csb” are computed. Further, the “Csp” is read out from the backup memory 42. If necessary, the “Csp” is multiplied by a correction coefficient.

In step S15, the final control input “Ct” for the fuel-cut period is computed. Specifically, the “Ct” is computed according to the following formula (2).

Ct=180−(Cn+Cfb+K2(Csp+Csb)) (2)

During the fuel-cut period, no fuel is injected through the fuel injector 23. Thus, the FF control input “Cff” is not utilized to compute the final control input “Ct”. If a total of the “Csb” and the “Csp” is an appropriate value corresponding to the fuel-return quantity, an increase and decrease in fuel quantity in the delivery pipe 25 is zero while the plunger 52 reciprocates once between the top dead center and the bottom dead center when the “Cfb” is zero. Meanwhile, if a total of the “Csb” and the “Csp” is not an appropriate value corresponding to the fuel-return quantity, or if there is a deviation between the target fuel pressure and the actual fuel pressure, the “Cfb” is not zero.

Further, when the “Cfb” is zero, “K2” is “1” (K2=1). When the “Cfb” is not zero, “K2” is determined based on the actual fuel pressure “Pac” and a ratio between “180−(Cn+Cfb)” and the “CP”.

It should be noted that a specific way for determining the correction coefficient “K2” is arbitrarily employed.

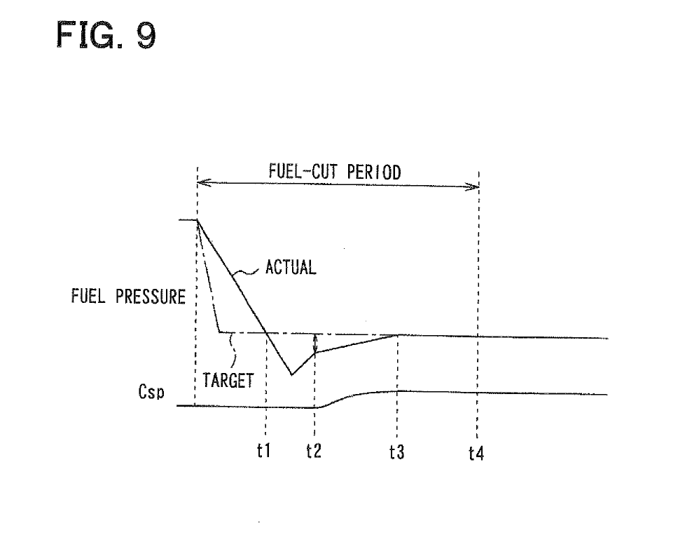

The electromagnetic valve 61 is energized at an energization start timing corresponding to the final control input “Ct” which is computed in step 815. In steps S16 and S17, the computer determines whether a learning condition for learning a deviation in the base correction input “Csb” is established. Referring to FIG. 9, the learning condition will be explained. FIG. 9 is a time chart in which the learning is executed. A solid line represents an actual fuel pressure and an alternate long and short dash line represents a target fuel pressure.

In the fuel-cut period, the target fuel pressure is finally set to a target fuel pressure at idling state (for example, 8 MPa). Thus, the fuel pressure in the delivery pipe 25 has been increased since the fuel-cut is started. Then, at a timing t1, the actual fuel pressure becomes lower than the target fuel pressure. At a timing t2, an absolute value of a deviation between the target fuel pressure and the actual fuel pressure becomes lower than a specified value.

In step S16, the computer determines whether a specified period has elapsed after the fuel-cut is started. This specified period is established in order to avoid a situation where the learning is started immediately after the fuel-cut is started. In step S17, the computer determines whether an absolute value of the deviation in the fuel pressure is lower than or equal to a specified value. Before the timing t2, the answer in step S16 or S17 is NO, so that the learning is not executed. At the timing t2, the learning condition is established. When the answers in step S16 and S17 are respectively YES, the procedure proceeds to step S18.

In step S108, a learning processing is executed. Specifically, the learning value input “Csp” is computed according to the following formula (3).

Csp=Csp+Cfbi/K2 (3)

When learning processing is executed once during the fuel-cut period, the learning processing is executed every when the control input is computed until the integral term “Cfbi” becomes zero. The learning value input “Csp” is stored in the backup memory 42 along with the engine speed “NE” and the actual fuel pressure “Pac”.

At the timing t2, the learning condition is established to start the learning processing. At the timing t3, the integral term “Cfbi” becomes zero to end the periodic execution of the learning processing. In this case, it is possible to obtain the learning value input “Csp” by executing the learning by using of the integral term “Cfbi” instead of the FB control input “Cfb” while restricting a variation in the learning value input “Csp”. At a timing t4, the fuel-cut is terminated.

According to this embodiment explained above, the following advantages are obtained.

The control input of the energization start timing of the electromagnetic valve 61, which corresponds to a control input of the fuel pump, is corrected by using of the base correction input “Csb” and the learning value input “Csp”. Thus, even in a fuel supply system provided with the pressure reduction mechanism 70, the reduced fuel pressure can be properly recovered. The fuel pressure in the delivery pipe 25 can be close to the target fuel pressure. Consequently, the fuel pressure in the delivery pipe 25 can be maintained at the target fuel pressure. The fuel injection control can be appropriately conducted.

During a driving of an engine 10, the learning value input “Csp” is computed and a deviation in the base correction input “Csb” relative to the pressure reduction by the pressure reduction mechanism 70 is corrected based on the learning value input “Csp”. Thereby, even if the pressure reduction mechanism 70 has an individual difference and an error due to its aging, the correction quantity can be properly obtained, which corresponds to the pressure reduction. Especially, since the learning value input “Csp” is computed during the fuel-cut period, it is unnecessary to consider fuel injection quantity through the fuel injector 23. Thus, the appropriate correction quantity can be obtained without complicate computation.

The learning value input “Csp” is computed by utilizing the FB control input “Cfb”. Thereby, the learning value input “Csp” can be computed by utilizing a configuration in which the actual fuel pressure is feedback controlled to agree with the target fuel pressure. Further, since the learning value input “Csp” is computed by utilizing the integral term “Cfbi”, a variation in the learning value input “Csp” can be restricted.

In the fuel-cut period, the target fuel pressure is set to the target fuel pressure for idling state. Thus, even if the fuel-cut is terminated earlier than expected, the fuel injection control can be properly conducted. In this case, when the absolute value of the deviation between the target fuel pressure and the actual fuel pressure becomes less than a specified value, the learning value input “Csp” is computed. The variation in the learning value input “Csp” can be restricted.

### Second Embodiment

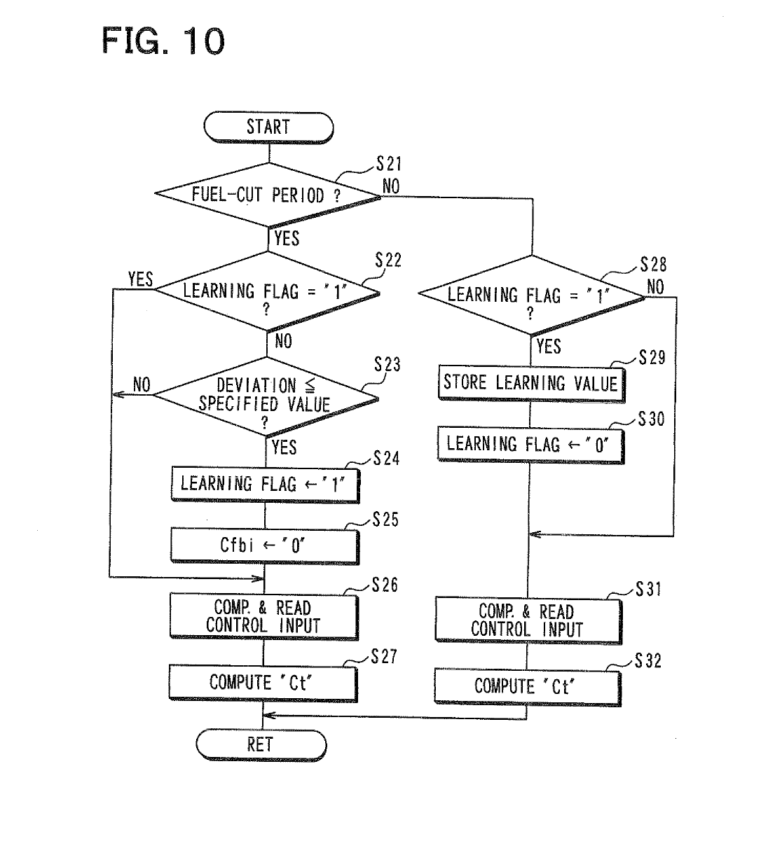

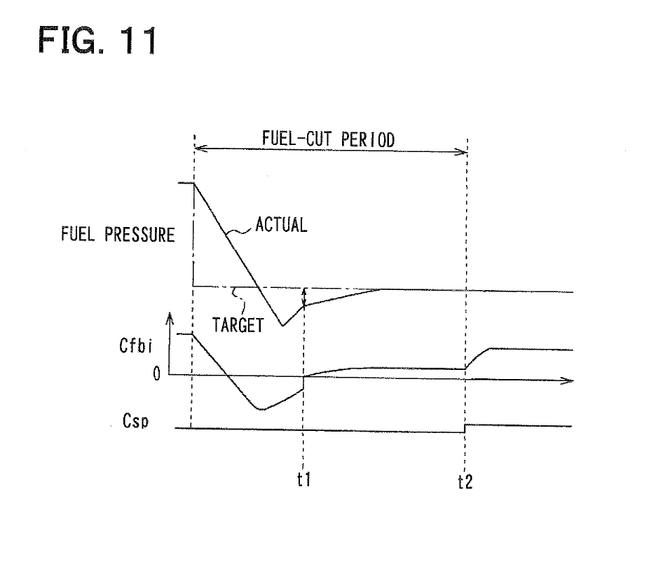

In a second embodiment, a learning processing is different form the first embodiment. Referring to FIGS. 10 and 11, this difference will be described. FIG. 10 is a flow chart showing a control input computing processing, and FIG. 11 is a timing chart showing a learning processing.

In step S21, the computer determines whether it is in the fuel-cut period. When the answer is YES, the procedure proceeds to step S22. In step S22, the computer determines whether a learning start flag is set to “1”. When the answer is NO in step S22, the procedure proceeds to step S23 in which the computer determines whether an absolute value of a deviation of the fuel pressure is less than or equal to a specified value. When the answer is YES in step S23, the computer determines that an initialization condition is established. The procedure proceeds to step S24 and step S25 in which an initialization is conducted. That is, in step S24, the learning start flag is set to “1”. In step S25, the integral temp “Cfbi” is cleared. The process in step S25 corresponds to a clear executing means of the present invention.

When the initialization condition is not established, or after the initialization is conducted, the procedure proceeds to step S26 in which various control inputs are computed and read out. Then, in step S27, the final control input “Ct” for the fuel-cut period is computed. These processes are the same as those in steps S14 and S15.

When the answer is NO in step S21, the procedure proceeds to step S28 in which the computer determines whether the learning start flag is set to “1”. When YES in step S28, the procedure proceeds to step S29 in which the learning value input is stored. Specifically, in step S29, the integral term “Cfbi” obtained during the last fuel-cut period is stored in the backup memory 42 as the learning value input “Csp”. In this case, the learning value input “Csp” is stored in relationship with the engine speed “NE” and the actual fuel pressure “Pac”. In step S30, the learning start flag is cleared.

When the answer is NO in step S28 or after the step S30, the procedure proceeds to step S31 in which various control inputs are computed and read out. Then, in step S32, the final control input “Ct” for the fuel-supply period is computed. These processes are the same as those in steps S12 and S13.

In the second embodiment, the integral term “Cfbi” is stored as the learning value input “Csp” after the fuel-cut period is terminated. By executing processes in steps S22 to S24, the integral term “Cfbi” is cleared at a timing t1 in FIG. 11. At the timing t1, the absolute value of a deviation in the fuel pressure becomes less than or equal to a specified value. Thereby, at a timing when the pressure reduction condition comes close to a stable condition from a transitional condition, the variation in the integral term “Cfbi” during the transitional period can be canceled. The computation of the integral term “Cfbi” can be conducted in a period where the variation in the deviation is relatively small.

At a timing t2 in FIG. 11, the learning value input “Csp” can be obtained form the integral term “Cfbi”. Thus, a followability of the actual fuel pressure relative to the target fuel pressure is enhanced.

### OTHER EMBODIMENT

The present invention is not limited to the above-mentioned embodiments, for example, may be performed as follows.

When the actual fuel pressure is greater than the target fuel pressure and the deviation therebetween is greater than a reference value during the fuel-cut period, the control input of the high-pressure pump 24 may not be advanced based on the correction control input “Cs”. That is, the high-pressure fuel pump 24 may not discharge the fuel. In this case, when the fuel-cut is started, the actual fuel pressure can be reduced to the target fuel pressure promptly while the fuel-return by the constant residual pressure valve 91 can be properly compensated during the fuel-supply period. In order to compute the learning value input “Csp” properly, the above reference value should be greater than or equal to the specified value in step S17 and the specified value in step S23. Especially, an overshoot quantity of the actual fuel pressure relative to the target fuel pressure can be reduced.

When the fuel-cut is started, the target fuel pressure can be stepwise decreased. Thereby, the learning value input “Csp” can be promptly obtained. Also, in a fuel-cut period, the target fuel pressure can be maintained for a specified period in which the learning value input “Csp” may be computed. In a case that the learning value input “Csp” is computed based on the integral term, the integral term should be cleared at timing when the fuel-cut is started.

The base correction input “Csb” and the learning value input “Csp” can be utilized without considering a variation in the fuel-return quantity. In this case, the correction coefficients “K1” and “K2” are not necessary to compute the final control input “Ct”.

The above formulas (1)-(3) are expressed as follows:

Ct=180−(Cn+(Cff+Cfb)+(Csp+Csb))

Ct=180−(Cn+Cfb+(Csp+Csb))

Csp=Csp+Cfbi.

According to this configuration, the computing load to compute the base correction input “Csb” and the learning value input “Csp” can be reduced.

When computing the learning value input “Csp” during the fuel-cut period, both the integral term “Cfbi” and the proportional term “Cfbp” can be utilized. Further, the feedback control is not limited to the PI control. Furthermore, the learning value input “Csp” can be computed based on another control input other than the FB control input “Cfb”.

A fuel temperature and an engine load in addition to the engine speed “NE” and the actual fuel pressure “Pac” can be used as parameters of the base correction input “Csb” and the learning value input “Csp”. The fuel temperature can be estimated from the engine coolant temperature detected by the coolant temperature sensor 31, The engine load may be determined based on a battery voltage.

The correction control input “Cs” may includes only one of the base correction input “Csb” and the learning value input “Csp”. For example, in a case that the correction control input “Cs” includes only the learning value input “Csp”, all of the correction control input “Cs” is computed and stored during engine driving. Further, the learning value input “Csp” can be erased when the ignition switch is turned off. That is, a value computed for compensating a deviation in the correction control input “Cs” is not always the learning value.

The final control input “Ct” for the fuel-supply period (step S13 and step S32) can be used as a retard quantity of the energization start timing which is determined based on the uncontrollable control input “Cn” and the effective control input “Cp”.

The high-pressure fuel pump 24 can be an electric fuel pump. In a case that an electric fuel pump is employed, the controller of the present invention can be applied to a vehicle having an idle reduction function and a hybrid vehicle. Besides, the check valve 65 can be replaced by an orifice.

The controller of the present invention can be applied to a fuel supply system of a diesel engine having a common-rail. The electromagnetic valve 61 can be a normally-open valve of which valve opening timing is controlled to control a discharge quantity of the high-pressure fuel pump 24.

The fuel in the delivery pipe 25 can be returned to the low-pressure passage 56 instead of the pressurization chamber 55. Further, in a case that the fuel in the delivery pipe 25 is returned to the pressurization chamber 55, the pressure reduction mechanism may have a fuel-return passage which is always opened. In this case, since the fuel is returned from the delivery pipe 25 even if the high-pressure pump 24 discharges the fuel, it is preferable that the correction control input “Cs” is computed in view of the fuel return. Further, the present invention can be applied to a fuel supply system which has no pressure reduction mechanism. Even in this case, the discharge quantity of the high-pressure pump can be controlled in view of fuel leak due to a delivery pipe configuration.

What is claimed is:

1. A controller for a fuel supply system of an internal combustion engine which is provided with a fuel pump discharging a fuel and a fuel-supply-passage portion accumulating the fuel discharged from the fuel pump in order to supply the fuel to a fuel injector, the controller controlling an control input of the fuel pump in such a manner that a fuel pressure in the fuel-supply-passage portion agrees with a target fuel pressure, the controller comprising:
a computing means for computing a correction input which compensates a fuel pressure reduction except due to a fuel injection through the fuel injector; and
a pump control means for controlling the control input of the fuel pump so that the fuel pump discharges the fuel according to the correction input computed by the computing means.

2. A controller for a fuel supply system according to claim 1, wherein
the computing means computes the correction input based on the fuel pressure in the fuel-supply-passage portion during a fuel-cut period in which no fuel is injected through the fuel injector while the engine is running.

3. A controller for a fuel supply system according to claim 2, further comprising:
an obtaining means for obtaining an actual fuel pressure in the fuel-supply-passage portion from a fuel pressure sensor; and
a feedback control means for computing a feedback control input based on a deviation between the actual fuel pressure and the target fuel pressure, wherein
the pump control means controls the control input of the fuel pump in such a manner that the fuel pump discharges the fuel in accordance with the correction input and the feedback control input, and
the computing means computes the correction input by utilizing the feedback control input computed by the feedback control means during the fuel-cut period.

4. A controller for a fuel supply system according to claim 3, wherein
the feedback control means computes an integral term of the deviation as a part of the feedback control input, and
the computing means computes the correction input by utilizing the integral term.

5. A controller for a fuel supply system according to claim 4, further comprising
a clear executing means for clearing the integral term after the fuel-cut period is started, wherein
the computing means computes the correction input by utilizing another integral term after the integral term is cleared by the clear executing means.

6. A controller for a fuel supply system according to claim 1, wherein
the fuel supply system is provided with a pressure reduction means for reducing the fuel pressure in the fuel-supply-passage portion by discharging the fuel therefrom in a direction away from the fuel injector by means of the fuel pressure in the fuel-supply-passage portion, and
the computing means computes the correction input for compensating a fuel quantity which the fuel pressure reduction means discharges from the fuel-supply-passage portion.

7. A controller for a fuel supply system according to claim 1, wherein
the fuel supply system is provided with a pressure reduction means for reducing the fuel pressure in the fuel-supply-passage portion by discharging the fuel therefrom in a direction away from the fuel injector by means of the fuel pressure in the fuel-supply-passage portion, and for reducing the fuel pressure in the fuel-supply-passage portion to a specified target fuel pressure in a fuel-cut period in which no fuel is injected through the fuel injector while the engine is running, the controller further comprising
an obtaining means for obtaining an actual fuel pressure in the fuel-supply-passage portion from a fuel pressure sensor; and
a feedback control means for computing a feedback control input based on a deviation between the actual fuel pressure and the target fuel pressure, wherein
the pump control means controls the control input of the fuel pump in such a manner that the fuel pump discharges the fuel in accordance with the correction input and the feedback control input, and
the computing means computes the correction input for compensating a fuel quantity which the fuel pressure reduction means discharges from the fuel-supply-passage portion, and
the computing means computes the correction input by utilizing the feedback control input in a case that the deviation becomes within a specified range after the fuel-cut period is started.

8. A controller for a fuel supply system according to claim 6, wherein
the control input defines a start timing of a fuel discharge from the fuel pump,
the pressure reduction means discharges the fuel from the fuel-supply-passage portion when the fuel pump pressurizes no fuel, and prevents the fuel from flowing out from the fuel-supply-passage portion when the fuel pump pressurizes the fuel in order to discharge the fuel, and
the computing means computes the correction input which advances the start timing of the fuel discharge as the start timing of the fuel discharge corresponding to the control input except the correction input is retarded,

9. A controller for a fuel supply system according to claim 7, wherein
the control input defines a start timing of a fuel discharge from the fuel pump,
the pressure reduction means discharges the fuel from the fuel-supply-passage portion when the fuel pump pressurizes no fuel, and prevents the fuel from flowing out from the fuel-supply-passage portion when the fuel pump pressurizes the fuel in order to discharge the fuel, and
the computing means computes the correction input which advances the start timing of the fuel discharge as the start timing of the fuel discharge corresponding to the control input except the correction input is retarded.
